(19) United States
(12) Patent Application Publication
(10) Pub. No.: US 2013/0032240 A1
(43) Pub. Date: Feb. 7, 2013

(54) FLEXIBLE PIPE HAVING A DIFFUSION BARRIER

(71) Applicants: Karl Kuhmann, Duelmen (DE); Andreas Dowe, Borken (DE); Rainer Goering, Borken (DE)

(72) Inventors: Karl Kuhmann, Duelmen (DE); Andreas Dowe, Borken (DE); Rainer Goering, Borken (DE)

(73) Assignee: EVONIK DEGUSSA GmbH, Essen (DE)

(21) Appl. No.: 13/640,586

(22) PCT Filed: Mar. 25, 2011
(86) PCT No.: PCT/EP2011/054578

§ 371 Date: Oct. 11, 2012

(30) Foreign Application Priority Data
Apr. 13, 2010 (DE) 10 2010 003 917.9

(51) Int. Cl. F16L 11/00

(52) U.S. Cl. 138/137

(57) ABSTRACT

In a flexible pipe of multilayer structure with unbonded layers, where the pipe has an interior lining which comprises the following layers:
a) at least one layer of which the material has been selected from the group of polyolefin moulding composition, polyamide moulding composition and polyvinylidene fluoride moulding composition, and also
b) at least one layer of which the material is composed of a moulding composition based on a polymer selected from the group of polyarylene ether ketone, polyphenylene sulphide, polyarylene ether ketone/polyphenylene sulphide blend, polyphenyl sulphone and polyalkylene naphthalate,
   the exterior reinforcement has particularly efficient protection from corrosion due to aggressive constituents which diffuse outwards from the fluid conveyed. The pipe therefore has particular suitability for offshore applications in the production of oil or of gas.

The present invention relates to a flexible pipe of multilayer structure with unbonded layers. For simplicity, it is hereinafter termed an unbonded flexible pipe. This type of pipe has high resistance to the diffusion of gases from any conveyed fluid, and can therefore be used with particular advantage for conveying crude oil, natural gas, methanol, CO₂ and the like.

Unbonded flexible pipes are per se prior art. Pipes of this type comprise an interior lining, usually in the form of a plastics tube, as barrier to escape of the conveyed fluid, and also one or more reinforcing layers on the external side of the said interior lining. The unbonded flexible pipe can comprise additional layers, examples being one or more reinforcing layers on the inner side of the interior lining, in order to inhibit collapse of the interior lining under high external pressure. This type of interior reinforcement is usually termed a carcass. There can also be an exterior sheath present, in order to provide a barrier to penetration of liquid from the exterior environment into the reinforcing layers or other internal polymeric or metallic functional layers.

Typical unbonded flexible pipes are described by way of example in WO 01/61232, U.S. Pat. No. 6,123,114 and U.S. Pat. No. 6,085,799; they are also described in more detail in API Recommended Practice 17B, “Recommended Practice for Flexible Pipe”, 3rd Edition, March 2002, and also in API Specification 17J, “Specification for Unbonded Flexible Pipe” 2nd Edition, November 1999.

The term “unbonded” in this context means that at least two of the layers, inclusive of reinforcing layers and plastics layers, have not been designed with bonding between the same. In practice, the pipe comprises at least two reinforcing layers which, over the length of the pipe, have been bonded to one another either directly or indirectly, i.e. by way of further layers. This makes the pipe sufficiently flexible that it can be rolled up for transport purposes.

Various embodiments of these unbonded flexible pipes are used in offshore applications, and also in various onshore applications, for transporting liquids, gases and slurries. By way of example, they can be used for transporting fluids where, over the length of the pipe, there is very high, or very different, water pressure, for example in the form of ascending pipelines which run from the sea bed up to equipment at or in the vicinity of the surface of the sea, or else in general terms in the form of pipes for transporting liquids or gases between various items of equipment, or in the form of pipes laid at great depth on the sea bed, or in the form of pipes between items of equipment in the vicinity of the surface of the sea.

In conventional flexible pipes, the reinforcing layer(s) is/are composed mostly of helically arranged steel wires, steel profiles or steel strip, and the individual layers here can have various winding angles relative to the axis of the pipe. Alongside this, there are also embodiments in which at least one reinforcing layer, or all of the reinforcing layers, is/are composed of fibres, for example of glass fibres, for example in the form of fibre bundles or of fibre textiles, generally embedded into a polymeric matrix.

In the prior art, the interior lining is usually composed of a polyolefin, such as polyethylene, which can also have been crosslinked, or of a polyamide, such as PA11 or PA12, or of polyvinylidene fluoride (PVDF).

Polyethylene has the disadvantage of swelling markedly in contact with crude oil or natural gas, and then undergoing creep. The non-polar fluid conveyed also permeates outwards to a major extent through the polyethylene wall. Polyethylene is therefore generally not used for lines with direct contact with product streams, but instead is mainly used for what are known as water injection lines.

Polyamides such as PA11 or PA12 have very good suitability as material for the interior lining, because they have very good mechanical properties and excellent resistance to hydrocarbons and exhibit only slight swelling. The particular suitability of polyamides has been described in detail in the publication OTC 5231 “Improved Thermoplastic Materials for Offshore Flexible Pipes”. However, they can be used only up to at most about 70° C., since the process water present in the crude oil or, respectively, natural gas causes increasing hydrolysis at higher temperatures. The said hydrolysis reduces the molecular weight of the polyamide so severely as to cause considerable impairment of mechanical properties and finally failure of the pipe. API 17TR2 describes a detailed test procedure for determining hydrolysis properties for PA11, and this can be applied equally to PA12.

PVDF is used up to at most 130° C. After modification, it is stiff with low compressive deformability even at relatively high temperatures up to about 130° C. However, blistering and microfoaming are likely to occur at temperatures above 130° C. with a decrease in internal pressure. PVDF undergoes major swelling extending to about 25% in particular in supercritical CO₂; the blistering that occurs with pressure decrease results from the good permeation barrier, which implies poor diffusion. Local gas desorption occurs within the layer here, whereupon the cohesive strength of the material is exceeded.

A general problem is that when unbonded flexible pipes of this type are used for conveying crude oil or natural gas or for transporting other aggressive fluids, undesired and corrosive constituents of the transported fluids diffuse through the interior lining and attack the wires or, respectively, profiles of the reinforcement system. This problem arises in particular with the outward permeation of hydrogen sulphide.

Use of high-alloy steel for the exterior reinforcing layers could be of assistance, but this is not only expensive but also increases the weight of the pipe, since high-alloy steels are often less strong than low-alloy steels and therefore require thicker dimensions to achieve comparable strength in the final product. The prior art therefore has various approaches to elimination of the said problem.

WO 00/17479 describes a solution in which the intermediate space between the interior lining and the exterior sheath can be flushed in order to remove undesired gases and liquids which diffuse through the interior lining into the intermediate space. However, this type of solution is complicated and cannot be implemented in every case.

WO 02/31394 proposes, in offshore applications, permitting seawater to come into contact with the exterior reinforcement layers, whereupon gases and liquids which diffuse through the interior lining are flushed away. However, seawater is itself corrosive.

U.S. Pat. No. 6,006,788 describes a flexible pipe with an interior, gas-tight corrugated metal tube. This tube is relatively stiff however, since the corrugated metal tube must have a minimum thickness in order to be mechanically stable. Furthermore, the metal tube itself has to be resistant to the aggressive fluid conveyed. Pipes of this type have therefore only limited application.

The object of the invention consists in providing an interior lining which inhibits the passage of aggressive constituents of the conveyed fluid so efficiently as to markedly reduce corrosion of the exterior reinforcing layers.

Surprisingly, the said problem can be solved by providing a barrier layer with respect to hydrogen sulphide and to other aggressive compounds.

WO 2005/028198 has previously addressed this type of concept. The interior lining in that document is composed of a relatively thick polymer layer and of a relatively thin film with barrier properties with respect to a fluid selected from the group consisting of methane, hydrogen sulphide, CO₂ and water. Two identical lists are given for the materials of the relatively thick polymer layer and of the film; the film can moreover be composed of metal. The examples provide evidence for this last embodiment. WO 2005/028198 does not therefore contain any teaching as to which polymer materials are to be combined in order to form an effective barrier specifically with respect to hydrogen sulphide, where this barrier is durably maintained even during operation under the required ambient conditions (high pressure differences and high temperatures).

The invention provides an unbonded flexible pipe where the pipe has an interior lining which comprises the following layers:

a) at least one layer of which the material has been selected from the group of polyolefin moulding composition, polyamide moulding composition and polyvinylidene fluoride (PVDF) moulding composition, and also

b) at least one layer of which the material is composed of a moulding composition based on a polymer selected from the group of polyarylene ether ketone, polyphenylene sulphide, polyarylene ether ketone/polyphenylene sulphide blend, polyphenyl sulphone and polyalkylene naphthalate.

The layer according to b) can have been positioned on the external side of the interior lining; however, it has preferably been arranged towards the inside.

It is also possible that still further layers are present alongside the layers according to a) and b), if specific functions are required.

There can be adhesion promoters bonding the individual layers to one another; suitable adhesion promoters are known to the person skilled in the art. A certain degree of initial adhesion facilitates production of the unbonded flexible pipe; however, layer adhesion is not a vital requirement for operation. In the event that gases accumulate between unbonded layers during operation, these can be dissipated by suitable design measures. However, accumulation of gases can be markedly reduced in the preferred embodiment when the layer according to b) has been arranged on the inside.

In one possible embodiment, there is a carcass located on the inner side of the interior lining. Carcasses of this type and their design are prior art. In another possible embodiment, the unbonded flexible pipe comprises no carcass, especially when it is not intended for operation under high external pressures.

The unbonded flexible pipe moreover comprises, on the external side of the interior lining, one or more reinforcing layers, which are usually composed of helically arranged steel wires, steel profiles, or steel strip. The design of the said reinforcing layers is prior art. The structure of at least one of the said reinforcing layers is preferably such that the layer withstands the internal pressure, and the structure of at least one other of the said reinforcing layers is such that the layer withstands tensile forces. The reinforcing layer(s) can be followed by an exterior sheath, usually in the form of a tube or hose made of a thermoplastic moulding composition or of an elastomer.

The polyolefin used for the layer according to a) can firstly be a polyethylene, in particular a high-density polyethylene (HDPE), or an isotactic or syndiotactic polypropylene. The polyethylene has preferably been crosslinked, usually either by way of reaction with free-radical initiators or by way of moisture-initiated crosslinking of grafted-on silyl groups. The polypropylene can be a homo- or copolymer, for example using ethylene or 1-butene as comonomer; it is possible here to use random copolymers and also block copolymers. The polypropylene can moreover also have been impact-modified, for example in accordance with the prior art by using ethylene-propylene rubber (EPM) or EPDM.

Polyvinylidene fluoride (PVDF) is known to the person skilled in the art and is available commercially in a wide variety of grades. It is usually used in the form of homopolymer. According to the invention, however, the polyvinylidene fluoride present can also comprise copolymers based on vinylidene fluoride which have up to 40% by weight of other monomers. Examples that may be mentioned of these additional monomers are: trifluoroethylene, chlorotrifluoroethylene, ethylene, propene and hexafluoropropene.

The polyolefin moulding composition or PVDF moulding composition can comprise the usual auxiliaries and additives. The proportion of PVDF or polyolefin is at least 50% by weight, preferably at least 60% by weight, particularly preferably at least 70% by weight, with particular preference at least 80% by weight and very particularly preferably at least 90% by weight.

The polyamide of the layer according to a) can be produced from a combination of diamine and dicarboxylic acid, from an ω-aminocarboxylic acid or from the corresponding lactam. In principle, it is possible to use any polyamide, such as PA6, PA66, or copolyamides on the same basis having units which derive from terephthalic acid and/or from isophthalic acid (generally termed PPA), and also PA9T and PA10T and blends of these with other polyamides. In one preferred embodiment, the monomer units of the polyamide comprise an average of at least 8, at least 9, or at least 10 carbon atoms. In the case of mixtures of lactams, it is the arithmetic average that is considered here. In the case of a combination of diamine and dicarboxylic acid, the arithmetic average of the number of carbon atoms of diamine and dicarboxylic acid in this preferred embodiment must be at least 8, at least 9, or at least 10. Examples of suitable polyamides are: PA610 (which can be produced from hexamethylenediamine [6 carbon atoms] and sebacic acid [10 carbon atoms], the average number of carbon atoms in the monomer units here therefore being 8), PA88 (which can be produced from octamethylenediamine and 1,8-octanedioic acid), PA8 (which can be produced from caprylolactam), PA612, PA810, PA108, PA9, PA613, PA614, PA812, PA128, PA1010, PA10, PA814, PA148, PA1012, PA11, PA1014, PA1212 and PA12. The production of the polyamides is prior art. It is also possible, of course, to use copolyamides based on these materials, and concomitant use can optionally also be made here of monomers such as caprolactam.

The polyamide can also be a polyetheramide. Polyetheramides are in principle known by way of example from DE-A 30 06 961. They comprise a polyetherdiamine as comonomer. Suitable polyetherdiamines are accessible by conversion of the corresponding polyetherdiols through reductive amination or coupling to acrylonitrile with subsequent hydrogenation (e.g. EP-A-0 434 244; EP-A-0 296 852). The number-average molecular weight of these is generally from 230 to 4000; their proportion, based on the polyetheramide, is preferably from 5 to 50% by weight.

Commercially available polyetherdiamines derived from propylene glycol are obtainable commercially from Huntsman as JEFFAMIN® D grades. In principle, polyetherdiamines derived from 1,4-butanediol or from 1,3-butanediol also have good suitability, as do mixed-structure polyetherdiamines, for example with random or blockwise distribution of the units deriving from the diols.

Mixtures of various polyamides can equally be used, as long as compatibility is adequate. Compatible polyamide combinations are known to the person skilled in the art; mention may be made here of the following combinations by way of example: PA12/PA1012, PA12/PA1212, PA612/PA12, PA613/PA12, PA1014/PA12 and PA610/PA12, and also corresponding combinations with PA11. In case of doubt, routine experiments can be used to determine compatible combinations.

In one possible embodiment, a mixture of from 30 to 99% by weight, preferably from 40 to 98% by weight, and particularly preferably from 50 to 96% by weight, of polyamide in the narrower sense is used with from 1 to 70% by weight, preferably from 2 to 60% by weight and particularly preferably from 4 to 50% by weight, of polyetheramide.

The moulding composition can comprise further components alongside polyamide, examples being impact modifiers, other thermoplastics, plasticizers and other conventional additives. The only requirement is that the polyamide forms the matrix of the moulding composition.

Examples of suitable impact modifiers are ethylene/α-olefin copolymers, preferably selected from

a) ethylene/C₃-C₁₂-α-olefin copolymers having from 20 to 96, preferably from 25 to 85, % by weight of ethylene. An example of a C₃-C₁₂-α-olefin used is propene, 1-butene, 1-pentene, 1-hexene, 1-octene, 1-decene or 1-dodecene. Typical examples here are ethylene-propylene rubber, and also LLDPE and VLDPE.

b) ethylene/C₃-C₁₂-α-olefin/unconjugated diene terpolymers having from 20 to 96, preferably from 25 to 85, % by weight of ethylene and up to at most about 10% by weight of an unconjugated diene, such as bicyclo[2.2.1]heptadiene, 1.4-hexadiene, dicyclopentadiene or 5-ethylidenenorbornene. A suitable C₃-C₁₂-α-olefin is likewise by way of example propene, 1-butene, 1-pentene, 1-hexene, 1-octene, 1-decene or 1-dodecene.

The production of these copolymers or terpolymers, for example with the aid of a Ziegler-Natta catalyst, is prior art.

Other suitable impact modifiers are styrene-ethylene/butylene block copolymers. Here, it is preferable to use styrene-ethylene/butylene-styrene block copolymers (SEBS), where these are obtainable via hydrogenation of styrene-butadiene-styrene block copolymers. However, it is also possible to use diblock systems (SEB) or multiblock systems. Block copolymers of this type are prior art.

These impact modifiers preferably comprise anhydride groups, where these are introduced in a known manner via thermal or free-radical reaction of the main-chain polymer with an unsaturated dicarboxylic anhydride, an unsaturated dicarboxylic acid or a monoalkly ester of an unsaturated dicarboxylic acid, at a concentration sufficient for good coupling to the polyamide. Examples of suitable reagents are maleic acid, maleic anhydride, monobutyl maleate, fumaric acid, citraconic anhydride, aconitic acid or itaconic anhydride. It is preferable that from 0.1 to 4% by weight of an unsaturated anhydride have been grafted onto the impact modifier by this method. According to the prior art, the unsaturated dicarboxylic anhydride or precursor thereof can also be used as graft together with another unsaturated monomer, such as styrene, α-methylstyrene or indene.

Other suitable impact modifiers are copolymers which contain units of the following monomers:

a) from 20 to 94.5% by weight of one or more α-olefins having from 2 to 12 carbon atoms,

b) from 5 to 79.5% by weight of one or more acrylic compounds, selected from
acrylic acid, methacrylic acid, and salts thereof,
esters of acrylic acid or, respectively, methacrylic acid with a C₁-C₁₂ alcohol, where these can optionally bear a free hydroxy or epoxy function,
acrylonitrile or methacrylonitrile,
acrylamides or methacrylamides,

c) from 0.5 to 50% by weight of an olefinically unsaturated epoxide, carboxylic anhydride, carboximide, oxazoline or oxazinone.

The said copolymer is by way of example composed of the following monomers, where this list is not exhaustive:

a) α-olefins, such as ethylene, propene, 1-butene, 1-pentene, 1-hexene, 1-octene, 1-decene or 1-dodecene;

b) acrylic acid, methacrylic acid, or salts thereof, for example with Na or Zn^{2⊕} as counterion; methyl acrylate, ethyl acrylate, n-propyl acrylate, n-butyl acrylate, isobutyl acrylate, n-hexyl acrylate, n-octyl acrylate, 2-ethylhexyl acrylate, isononyl acrylate, dodecyl acrylate, methyl methacrylate, ethyl methacrylate, n-propyl methacrylate, n-butyl methacrylate, isobutyl methacrylate, 2-ethylhexyl methacrylate, hydroxyethyl acrylate, 4-hydroxybutyl methacrylate, glycidyl acrylate, glycidyl methacrylate, acrylonitrile, methacrylonitrile, acrylamide, N-methylacrylamide, N,N-dimethylacrylamide, N-ethylacrylamide, N-hydroxyethylacrylamide, N-propylacrylamide, N-butylacrylamide, N-(2-ethylhexyl)acrylamide, methacrylamide, N-methylmethacrylamide, N,N-dimethylmethacrylamide, N-ethylmethacrylamide, N-hydroxyethyl-methacrylamide, N-propylmethacrylamide, N-butylmethacrylamide, N,N-dibutylmethacrylamide, N-(2-ethylhexyl)methacrylamide;

c) vinyloxirane, allyloxirane, glycidyl acrylate, glycidyl methacrylate, maleic anhydride, aconitic anhydride, itaconic anhydride, and also the dicarboxylic acids produced from these anhydrides via reaction with water; maleimide, N-methylmaleimide, N-ethylmaleimide, N-butylmaleimide, N-phenylmaleimide, aconitimide, N-methylaconitimide, N-phenylaconitimide, itaconimide, N-methylitaconimide, N-phenylitaconimide, N-acryloylcaprolactam, N-methacryloylcaprolactam, N-acryloyllaurolactam, N-methacryloyllaurolactam, vinyloxazoline, isopropenyloxazoline, allyloxazoline, vinyloxazinone, or isopropenyloxazinone.

If glycidyl acrylate or glycidyl methacrylate is used, this compound also simultaneously functions as acrylic compound b), and if the amount of glycidyl (meth)acrylate is adequate there is therefore no need for the presence of any further acrylic compound. In this specific embodiment, the copolymer contains units of the following monomers:

a) from 20 to 94.5% by weight of one or more α-olefins having from 2 to 12 carbon atoms,

b) from 0 to 79.5% by weight of one or more acrylic compounds, selected from
acrylic acid, methacrylic acid and salts thereof,
esters of acrylic acid or, respectively, methacrylic acid with a C₁-C₁₂ alcohol,
acrylonitrile or methacrylonitrile,
acrylamides or methacrylamides,

c) from 0.5 to 80% by weight of an ester of acrylic acid or methacrylic acid, where the ester contains an epoxy group,

where the entirety of b) and c) is at least 5.5% by weight.

The copolymer can contain a small amount of other copolymerized monomers as long as these do not significantly impair properties, an example being dimethyl maleate, dibutyl fumarate, diethyl itaconate, or styrene.

The production of these copolymers is prior art. A wide variety of types of these is obtainable commercially, for example as LOTADER® (Arkema; ethylene/acrylate/tercomponent or ethylene/glycidyl methacrylate).

In one preferred embodiment, this polyamide moulding composition comprises the following components:

1. from 60 to 96.5 parts by weight of polyamide,

2. from 3 to 39.5 parts by weight of an impact-modifying component which contains anhydride groups, where the impact-modifying component has been selected from ethylene/α-olefin copolymers and styrene-ethylene/butylene block copolymers,

3. from 0.5 to 20 parts by weight of a copolymer which contains units of the following monomers:

a) from 20 to 94.5% by weight of one or more α-olefins having from 2 to 12 carbon atoms,

b) from 5 to 79.5% by weight of one or more acrylic compounds, selected from
acrylic acid, methacrylic acid and salts thereof,
esters of acrylic acid or, respectively, methacrylic acid with a C₁-C₁₂ alcohol, where this can optionally bear a free hydroxy or epoxy function,
acrylonitrile or methacrylonitrile,
acrylamides or methacrylamides,

c) from 0.5 to 50% by weight of an olefinically unsaturated epoxide, carboxylic anhydride, carboximide, oxazoline or oxazinone,

where the total of the parts by weight of components according to 1., 2., and 3. is 100.

In another preferred embodiment, this moulding composition comprises:

1. from 65 to 90 parts by weight and particularly preferably from 70 to 85 parts by weight of polyamide,

2. from 5 to 30 parts by weight, particularly preferably from 6 to 25 parts by weight and with particular preference from 7 to 20 parts by weight of the impact-modifying component,

3. from 0.6 to 15 parts by weight and particularly preferably from 0.7 to 10 parts by weight of the copolymer, which preferably contains units of the following monomers:

a) from 30 to 80% by weight of α-olefin(s),

b) from 7 to 70% by weight and particularly preferably from 10 to 60% by weight of the acrylic compound(s),

c) from 1 to 40% by weight and particularly preferably from 5 to 30% by weight of the olefinically unsaturated epoxide, carboxylic anhydride, carboximide, oxazoline, or oxazinone.

Another impact-modifying component that can also be used is nitrile rubber (NBR) or hydrogenated nitrile rubber (HNBR), where these optionally contain functional groups. US2003/0220449A1 describes corresponding moulding compositions.

Other thermoplastics which can be present in the polyamide moulding composition are primarily polyolefins. In one embodiment, as described at an earlier stage above in relation to the impact modifiers, they can contain anhydride groups, and are then optionally present together with an unfunctionalized impact modifier. In another embodiment, these are unfunctionalized and are present in the moulding composition in combination with a functionalized impact modifier or with a functionalized polyolefin. The term “functionalized” means that the polymers have been provided according to the prior art with groups that can react with the end groups of the polyamide, examples being anhydride groups, carboxy groups, epoxy groups, or oxazoline groups. Preference is given here to the following constitutions:

1. from 50 to 95 parts by weight of polyamide,

2. from 1 to 49 parts by weight of functionalized or unfunctionalized polyolefin, and also

3. from 1 to 49 parts by weight of functionalized or unfunctionalized impact modifier,

where the total of the parts by weight of components according to 1., 2., and 3. is 100.

The polyolefin is by way of example polyethylene or polypropylene. In principle, it is possible to use any commercially available grade. Examples of those that can be used are therefore: high-, medium-, or low-density linear polyethylene, LDPE, ethylene-acrylate copolymers, ethylene-vinyl acetate copolymers, isotactic or atactic homopolypropylene, random copolymers of propene with ethene and/or 1-butene, ethylene-propylene block copolymers, etc. The polyolefin can be produced by any known process, for example by the Ziegler-Natta or the Phillips process, or by means of metallocenes, or by a free-radical route. In this case the polyamide can also be, for example, PA6 and/or PA66.

In one possible embodiment, the moulding composition comprises from 1 to 25% by weight of plasticizer, particularly preferably from 2 to 20% by weight, and with particular preference from 3 to 15% by weight.

Plasticizers and their use with polyamides are known. A general overview of plasticizers suitable for polyamides can be found in Gächter/Müller, Kunststoffadditive [Plastics Additives], C. Hanser Verlag, 2nd Edition, p. 296.

Examples of conventional compounds suitable as plasticizers are esters of p-hydroxybenzoic acid having from 2 to 20 carbon atoms in the alcohol component, or amides of arylsulphonic acids having from 2 to 12 carbon atoms in the amine component, preferably amides of benzenesulphonic acid. Plasticizers that can be used are inter alia ethyl p-hydroxybenzoate, octyl p-hydroxybenzoate, isohexadecyl p-hydroxybenzoate, N-n-octyltoluene-sulphonamide, N-n-butyl benzenesulphonamide, or N-2-ethylhexylbenzene-sulphonamide.

The moulding composition can moreover also comprise conventional amounts of additives which are needed in order to establish certain properties. Examples of these are pigments or fillers, such as carbon black, titanium dioxide, zinc sulphide, reinforcing fibres, e.g. glass fibres, processing aids, such as waxes, zinc stearate or calcium stearate, antioxidants, UV stabilizers, and also additions which give the product antielectrostatic properties, for example carbon fibres, graphite fibrils, stainless-steel fibres, or conductive carbon black.

The proportion of polyamide in the moulding composition is at least 50% by weight, preferably at least 60% by weight, particularly preferably at least 70% by weight, with particular preference at least 80% by weight and very particularly preferably at least 90% by weight.

The polyarylene ether ketone of the layer according to b) comprises units of the formulae

(—Ar—X—)

and

(—Ar′—Y—),

where Ar and Ar' are a divalent aromatic moiety, preferably 1,4-phenylene, 4,4′-biphenylene, or else 1,4-, 1,5- or 2,6-naphthylene. X is an electron-withdrawing group, preferably carbonyl or sulphonyl, while Y is another group, such as 0, S, CH₂, isopropylidene or the like. At least 50%, preferably at least 70% and particularly preferably at least 80%, of the groups X here are a carbonyl group, while at least 50%, preferably at least 70% and particularly preferably at least 80% of the groups Y are composed of oxygen.

In the preferred embodiment, 100% of the groups X are composed of carbonyl groups and 100% of the groups Y are composed of oxygen. In the said embodiment, the polyarylene ether ketone can by way of example be a polyether ether ketone (PEEK; formula I), a polyether ketone (PEK; formula II), a polyether ketone ketone (PEKK; formula III) or a polyether ether ketone ketone (PEEKK; formula IV), but other arrangements of the carbonyl groups and oxygen groups are naturally also possible.

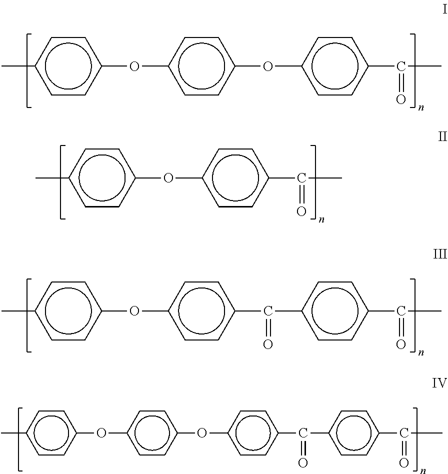

The polyarylene ether ketone is semicrystalline, and this is discernible by way of example in DSC analysis through appearance of a crystallite melting point Tₘ, which in most instances is of the order of magnitude of 300° C. or thereabove.

The polyphenylene sulphide comprises units of the formula

(—C₆H₄—S—);

and is preferably composed of at least 50% by weight, at least 70% by weight or at least 90% by weight of the said units. The remaining units can be those stated above for the case of the polyarylene ether ketone, or tri- or tetrafunctional branching-point units, where these result from concomitant use of, for example, trichlorobenzene or tetrachlorobenzene during synthesis. A wide variety of grades of, or moulding compositions comprising, polyphenylene sulphide are commercially available.

In the case of the polyarylene ether ketone/polyphenylene sulphide blends, the two components can be present in any conceivable mixing ratio, and the entire range of composition is therefore covered, from pure polyarylene ether ketone extending to pure polyphenylene sulphide. The blend generally comprises at least 0.01% by weight of polyarylene ether ketone and, respectively, at least 0.01% by weight of polyphenylene sulphide. In one preferred embodiment the blend comprises at least 50% by weight of polyarylene ether ketone.

Polyphenyl sulphone (PPSU) is produced industrially from the monomers 4,4′-dihydroxybiphenyl and 4,4′-dichlorodiphenyl sulphone. It is obtainable commercially by way of example as RADEL R®.

The polyalkylene naphthalate derives from an aliphatic or cycloaliphatic diol having from 2 to 8 carbon atoms, and also from a naphthalenedicarboxylic acid. Examples of suitable diols are ethanediol, 1,3-propanediol, 1,4-butanediol, 1,5-pentanediol, 1,6-hexanediol, 1,8-octanediol, neopentyl glycol and 1,4-cyclohexanedimethanol. Examples of suitable naphthalenedicarboxylic acids are 1,4-, 1,5-, 2,6- and 2,7-naphthalenedicarboxylic acid. Preferred polyalkylene naphthalates are in particular polyethylene 2,6-naphthalate, polypropylene 2,6-naphthalate, polybutylene 2,6-naphthalate and polyhexylene 2,6-naphthalate.

The moulding composition of the layer according to b) can comprise the conventional auxiliaries and additives and also optionally further polymers, examples being, in the case of the polyarylene ether ketone, fluoropolymers, such as PFA (a copolymer of tetrafluoroethylene and perfluorinated vinyl methyl ether), polyimide, polyetherimide, LCP, for example liquid-crystalline polyester, polysulphone, polyether sulphone, polyphenyl sulphone, polybenzimidazole (PBI) or other high-temperature-resistant polymers, and examples in the case of the polyphenylene sulphide being copolymers and, respectively, terpolymers of ethylene with polar comonomers. The proportion of polyarylene ether ketone, polyphenylene sulphide, polyarylene ether ketone/polyphenylene sulphide blend, polyphenyl sulphone or polyalkylene naphthalate is at least 50% by weight, preferably at least 60% by weight, particularly preferably at least 70% by weight, with particular preference at least 80% by weight and very particularly preferably at least 90% by weight.

Examples of possible layer arrangements, in each case from the outside to the inside, are:

polyamide/polyarylene ether ketone

polyamide/PPS

polyamide/PPS/polyamide

polyamide/polyalkylene naphthalate/polyamide

polyamide/polyalkylene naphthalate/polyamide/fluoropolymer

polyamide/polyalkylene naphthalate/polypropylene

polyamide/polyalkylene naphthalate/polypropylene/fluoropolymer

polyamide/polyalkylene naphthalate/HDPE

polyamide/polyalkylene naphthalate/syndiotactic polystyrene/fluoropolymer

polyarylene ether ketone/polyamide

polyarylene ether ketone/polyamide/polyarylene ether ketone

PPS/polyamide

HDPE or PP/polyarylene ether ketone

HDPE or PP/PPS

HDPE or PP/PPS/HDPE or PP

HDPE or PP/polyphenyl sulphone/HDPE or PP

PVDF/polyarylene ether ketone

PVDF/polyarylene ether ketone/PVDF

PVDF/PPS

PVDF/PPS/other fluoropolymer

PVDF/polyphenyl sulphone/PVDF

PVDF/polyphenyl sulphone/PP

The HDPE here can be uncrosslinked or preferably crosslinked HDPE.

The internal diameter of the interior lining is generally at least 30 mm, at least 40 mm, at least 50 mm or at least 60 mm, and also at most 900 mm, at most 800 mm, at most 700 mm or at most 620 mm; however, it can in individual cases also be greater or less than those values. The total wall thickness of the interior lining is generally at least 2 mm, at least 2.5 mm, at least 3 mm, at least 4 mm or at least 5 mm, and also at most 50 mm, at most 40 mm, at most 30 mm, at most 25 mm, at most 20 mm or at most 16 mm; again, it can in individual cases also be greater or less than those values. The thickness of the layer according to b) made of the barrier-layer material is from 0.5 to 50%, preferably from 1 to 40% and particularly preferably from 2 to 30%, of the total wall thickness. The thickness of the layer according to b) here is preferably at most 10 mm.

The interior lining is produced according to the prior art by coextrusion, by helical extrusion of the individual layers or optionally by winding of tapes.

The combination of layers according to the invention can efficiently suppress permeation of corrosive constituents, such as H₂S. This gives a considerable reduction in the risk of corrosion at the exterior reinforcing layers. It therefore becomes possible to use stronger, lower-alloy steels instead of high-alloy steels. This facilitates design with retention of identical strength values. The overall effect here is that the weight of the line can be reduced, and it therefore becomes possible to operate at greater undersea depths.

In another advantageous embodiment of the invention, the exterior sheath also uses a material which has a high permeation value for aggressive components, such as hydrogen sulphide and the like. Examples of suitable materials are LDPE, LLDPE, and also elastomers, such as Santoprene™ This method prevents accumulation, in the intermediate space between interior lining and exterior sheath, of the small amounts of the abovementioned substances which, despite all precautions, permeate through the interior lining. Corrosion risk is thus still further reduced.

1. A flexible pipe comprising a multilayer structure comprising an unbonded layer, wherein an interior lining of the pipe comprises:
(a) a first layer comprising a material selected from the group consisting of a polyolefin molding composition, a polyamide molding composition, and a polyvinylidene fluoride molding composition; and
(b) a second layer comprising a material comprising a molding composition comprising a polymer selected from the group of polyarylene ether ketone, polyphenylene sulphide, polyarylene ether ketone/polphenylene sulphide blend, polyphenyl sulphone, and polyalkylene naphthalate.

2. The flexible pipe of claim 1, wherein the interior lining is a pipe.

3. The flexible pipe of claim 1, wherein the layer (b) is arranged toward the inside, as seen from the layer (a).

4. The flexible of claim 1, comprising, alongside the interior lining, at least one layer selected from the group consisting of an internal carcass, an external reinforcing layer, and an exterior sheath.

5. The flexible pipe of claim 1, wherein an internal diameter of the interior lining is in a range from 30 to 900 mm and has a wall thickness in a range from 2 to 50 mm.

6. The flexible pipe of claim 1, wherein an internal diameter of the interior lining is in a range from 40 to 800 mm and has a wall thickness in a range from 2.5 to 40 mm.

7. The flexible pipe of claim 1, wherein an internal diameter of the interior lining is in a range from 50 to 700 mm and has a wall thickness in a range from 3 to 30 mm.

8. The flexible pipe of claim 1, wherein an internal diameter of the interior lining is in a range from 60 to 620 mm and has a wall thickness in a range from 4 to 25 mm.

9. The flexible pipe of claim 1, wherein an internal diameter of the interior lining is in a range from 60 to 620 mm and has a wall thickness in a range from 5 to 20 mm.

10. The flexible pipe of claim 7, wherein the thickness of the layer (b) is from 0.5 to 50% of the total wall thickness.

11. The flexible pipe of claim 8, wherein the thickness of the layer (b) is from 1 to 40% of the total wall thickness.

12. The flexible pipe of claim 9, wherein the thickness of the layer (b) is from 2 to 30% of the total wall thickness.

13. The flexible pipe of claim 1, wherein the layer (a) comprises a polyolefin molding composition.

14. The flexible pipe of claim 1, wherein the layer (a) comprises a polyamide molding composition.

15. The flexible pipe of claim 1, wherein the layer (a) comprises a polyvinylidene fluoride molding composition.

16. The flexible pipe of claim 1, wherein the material of layer (b) comprises a molding composition comprising a polyarylene ether ketone polymer.

17. The flexible pipe of claim 1, wherein the material of layer (b) comprises a molding composition comprising a polyphenylene sulphide polymer.

18. The flexible pipe of claim 1, wherein the material of layer (b) comprises a molding composition comprising a polyarylene ether ketone/polyphenylene sulphide blend polymer.

19. The flexible pipe of claim 1, wherein the material of layer (b) comprises a molding composition comprising a polyphenyl sulphone polymer.

20. The flexible pipe of claim 1, wherein the material of layer (b) comprises a molding composition comprising a polyalkylene naphthalate polymer.
